(19) United States
(12) Patent Application Publication
(10) Pub. No.: US 2008/0257816 A1
(43) Pub. Date: Oct. 23, 2008

(54) Structure of filter

(76) Inventor: Mao-Chang Lin, Taipei Hisen (TW)

Correspondence Address: MAO-CHANG LIN, 235 Chung-Ho Box 8-24, Taipei, TW

(21) Appl. No.: 11/788,842

(22) Filed: Apr. 23, 2007

(51) Int. Cl. B01D 35/02

(52) U.S. Cl. 210/463

(57) ABSTRACT

An engagement structure of a filter comprises an upper cover; a middle side of the upper cover being formed with an outer thread; a tapered portion being extended from a lower end of the portion of the upper cover having the outer thread; and a tube having a flange at an upper side thereof; an inner side of the tube being formed with an inner thread which is corresponding to the outer thread of the upper cover; a tapered hole being extended at an inner side of the tube and below the portion of the tube having the inner thread; the tapered hole having a shape corresponding to that of the tapered portion of the upper cover. An outer periphery of the tapered portion or an inner periphery of the tapered hole is formed with a plurality of annular grooves for receiving a plurality of washers.

### FIELD OF THE INVENTION

The present invention relates to filters, and particularly to an engagement structure of a filter, wherein the lifetime of the washers is prolonged. Further, a tapered portion extended from the lower side of an upper cover has the effect of reduction of the compression ratio in the manufacturing process so that the precision can be reduced. As a result, each time, a plurality of products can be made simultaneously so that mass production is possible and the cost is low.

### BACKGROUND OF THE INVENTION

Referring to FIGS. 1 and 2, a prior art filter is illustrated. The filter has the following elements.

An upper cover 2 has a water inlet 20 and a water outlet 21 at an upper side thereof. A lower side of the upper cover 2 is formed with an outer thread 22.

A tube 1 has a flange 10 at an upper side thereof. An inner side of the tube 1 is formed with an inner thread 11 which is corresponding to the outer thread 22 of the upper cover 2. A washer 12 is installed at a connection between the tube 1 and the upper cover 2 for preventing water from draining out.

However the prior art has some defects, such as the deformation of the washer 12 as the upper cover 2 rotates with respect to the tube 1 so that the washer 12 is worn and thus for a long time the water stop effect of the washer 12 is reduced.

Moreover, a length of the outer thread 22 must be equal to that of the inner thread 11 for effectively resisting against the washer 12. However this must require that in the manufacturing process, the precision is very high for overcoming the compression of the material in the manufacturing process, but this will induce that the products cannot be massively produced. Each time, only one is formed. It is uneconomical and inefficient.

### SUMMARY OF THE INVENTION

Accordingly, the primary object of the present invention is to provide an engagement structure of a filter, wherein the lifetime of the washers is prolonged. Further, a tapered portion extended from the lower side of a upper cover has the effect of reduction of the compression ratio in the manufacturing process so that the precision can be reduced. As a result, each time, a plurality of products can be made simultaneously so that mass production is possible and the cost is low.

To achieve above objects, the present invention provides an engagement structure of a filter comprising: an upper cover having an water inlet and an water outlet at an upper side thereof; a middle side of the upper cover being formed with an outer thread; a tapered portion being extended from a lower end of the portion of the upper cover having the outer thread; and a tube having a flange at an upper side thereof; an inner side of the tube being formed with an inner thread which is corresponding to the outer thread of the upper cover; a tapered hole being extended at an inner side of the tube and below the portion of the tube having the inner thread; the tapered hole having a shape corresponding to that of the tapered portion of the upper cover so that the upper cover can be engaged to the tube.

An outer periphery of the tapered portion is formed with a plurality of annular grooves for receiving a plurality of washers and the washers slightly protrude from the annular grooves.

Or an inner periphery of the tapered hole is formed with a plurality of annular grooves for receiving a plurality of washers and the washers slightly protrude from the annular grooves.

The various objects and advantages of the present invention will be more readily understood from the following detailed description when read in conjunction with the appended drawing.

### BRIEF DESCRIPTION OF THE DRAWINGS

FIG. 1 is an exploded perspective view of the prior art engagement structure of a filter.

FIG. 2 is an assembled cross sectional view about the structure illustrated in FIG. 1.

FIG. 3 is an exploded perspective view of the present invention.

FIG. 4 is an assembled view of the present invention.

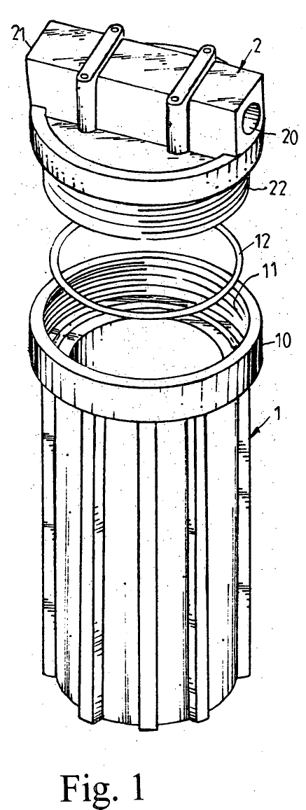

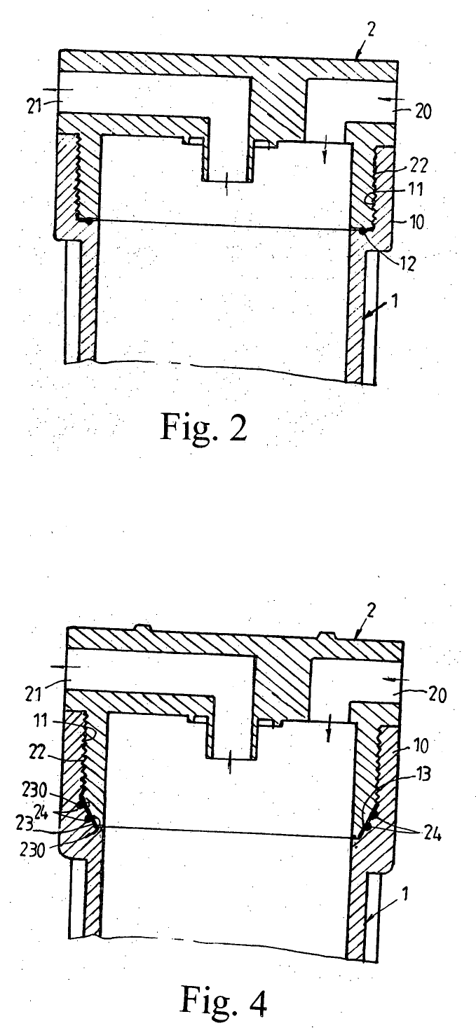

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

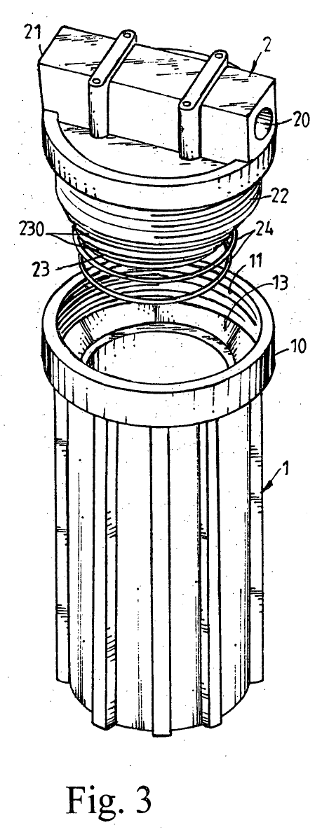

Referring to FIGS. 3 and 4, a filter of the present invention is illustrated. The filter has the following elements.

An upper cover 2 has a water inlet 20 and a water outlet 21 at an upper side thereof. A middle side of the upper cover 2 is formed with an outer thread 22. A tapered portion 23 is extended from a lower end of the portion of the upper cover 2 having the outer thread 22. An outer periphery of the tapered portion 23 is formed with a plurality of annular grooves 230 for receiving a plurality of washers 24 and the washers 24 slightly protrude from the annular grooves 230.

A tube 1 has a flange 10 at an upper side thereof. An inner side of the tube 1 is formed with an inner thread 11 which is corresponding to the outer thread 22 of the upper cover 2. A tapered hole 13 is extended at an inner side of the tube 1 and below the portion of the tube 1 having the inner thread 11. The tapered hole 13 has a shape corresponding to that of the tapered portion 23 of the upper cover 2.

Thereby in screwing the upper cover 2 to the tube 1, by the effect of the washers 24, the upper cover 2 will be tightly engaged to the tube 1, but the washers 24 will not deform because no force is applied to the upper and lower side of the washers 24. Thereby the lifetime of the washers 24 is prolonged. Further, the tapered portion 23 extended from the lower side of the upper cover 2 has the effect of reduction of the compression ratio in the manufacturing process so that the precision can be reduced. As a result, each time, a plurality of products can be made simultaneously so that mass production is possible and the cost is low.

Moreover, in another embodiment of the present invention, the annular grooves for receiving the washers can be formed on the tapered hole 13, this can get the same effect.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A engagement structure of a filter comprising:
an upper cover having an water inlet and an water outlet at an upper side thereof; a middle side of the upper cover being formed with an outer thread; a tapered portion being extended from a lower end of the portion of the upper cover having the outer thread; and
a tube having a flange at an upper side thereof; an inner side of the tube being formed with an inner thread which is corresponding to the outer thread of the upper cover; a tapered hole being extended at an inner side of the tube and below the portion of the tube having the inner thread; the tapered hole having a shape corresponding to that of the tapered portion of the upper cover so that the upper cover can be engaged to the tube.

2. The filter as claimed in claim 1, wherein an outer periphery of the tapered portion is formed with a plurality of annular grooves for receiving a plurality of washers and the washers slightly protrude from the annular grooves.

3. The filter as claimed in claim 1, wherein an inner periphery of the tapered hole is formed with a plurality of annular grooves for receiving a plurality of washers and the washers slightly protrude from the annular grooves.
